(19) United States
(12) Patent Application Publication
(10) Pub. No.: US 2012/0156589 A1
(43) Pub. Date: Jun. 21, 2012

(54) ELECTRODE CATALYST FOR FUEL CELL, MANUFACTURING METHOD THEREOF, AND FUEL CELL USING THE SAME

(75) Inventors: Suk-gi HONG, Seongnam-si (KR); Chan-ho Pak, Seoul (KR)

(73) Assignee: Samsung Electronics Co., Ltd., Suwon-si (KR)

(21) Appl. No.: 13/195,896

(22) Filed: Aug. 2, 2011

(30) Foreign Application Priority Data
Dec. 15, 2010 (KR) 10-2010-0128625

(51) Int. Cl. H01M 8/10; B01J 31/02

(52) U.S. Cl. 429/485; 502/167; 502/101

(57) ABSTRACT

An electrode catalyst for a fuel cell with excellent durability, a manufacturing method thereof, and a fuel cell using the same. The electrode catalyst for the fuel cell includes a carbon support, a metal catalyst material supported by the carbon support, and a benzimidazole-based or benzotriazole-based compound.

### CROSS-REFERENCE TO RELATED APPLICATIONS

This application claims the benefit of Korean Patent Application No. 10-2010-0128625, filed on Dec. 15, 2010 in the Korean Intellectual Property Office, the disclosure of which is incorporated herein in its entirety by reference.

### BACKGROUND

1. Field

Aspects of the present invention relate to an electrode catalyst for a fuel cell with excellent durability, a manufacturing method thereof, and a fuel cell using the same.

2. Description of the Related Art

A fuel cell is a generation-type cell directly converting chemical reaction energy of hydrogen and oxygen to electrical energy. Being different from an ordinary battery, the fuel cell may produce electricity as long as hydrogen and oxygen are provided from the outside. In comparison with the typical method which loses efficiency throughout multiple steps of generating electricity, the fuel cell may directly generate electricity resulting in two times higher efficiency than that of an internal combustion engine, not to speak of reducing risks of environmental contamination and depletion of natural resources.

According to the type of fuel used, fuel cells may be classified as polymer electrolyte membrane fuel cells (PEMFC), direct methanol fuel cells (DMFC), phosphoric acid fuel cells (PAFC), molten carbonate fuel cells (MCFC), or solid oxide fuel cells (SOFC).

PEMFCS and DMFCs are usually composed of a membrane-electrode assembly (MEA) including an anode, a cathode, and a polymer electrolyte membrane disposed between the anode and the cathode. When an oxidation reaction of fuel occurs at the anode to which hydrogen or fuel is provided, a hydrogen ion generated in the anode is transmitted to the cathode through the electrolyte membrane, and a reduction reaction occurs at the cathode to which oxygen is provided to finally generate electricity based on the voltage difference between the two electrodes.

An anode and a cathode of a fuel cell usually include a catalyst layer including a catalyst, and an electrode base material supporting the catalyst layer. The electrode base material includes a gas diffusion layer facilitating diffusion of fuel and gas and, if necessary, may further include a fine pores layer.

Platinum is usually used as a catalyst in the catalyst layer. Due to the high price, platinum is usually supported by carbon for application.

In accordance with an attempt to improve catalyst activation, increase durability against carbon monoxide poisoning, facilitate collection of arrangements, and simplify the system, the high-temperature operation polymer electrolyte membrane fuel cell is attracting attention these days. A polybenzimidazole membrane impregnated with phosphoric acid is usually used as a high-temperature operation polymer electrolyte. However, there are problems of degradation of the catalyst during the high temperature operation, and leakage of phosphoric acid electrolytes, especially during the high current operation of a fuel cell for cars or the daily operations of start up and shut down (DSS) of home fuel cells.

### SUMMARY

Aspects of the present invention provide an electrode catalyst for a fuel cell with an excellent durability at high temperature operation, a method of manufacturing the same, and a fuel cell composed of an electrode including the same.

According to an aspect of the present invention, an electrode catalyst for a fuel cell includes a carbon support; a metal catalyst material supported by the carbon support; and a compound of Formula 1 below combined with the carbon support,

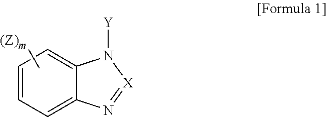

wherein in the Formula 1:

X is N or CR¹, where R¹ is a hydrogen atom, C₁-C₆ alkyl or C₁-C₆ haloalkyl,

Y is a hydrogen atom, C₁-C₆ alkyl or C₁-C₆ haloalkyl,

Z is halo, cyano, nitro or hydroxy,

m is an integer of 0 to 3, and

when m is 2 or more, multiple Z's are either same as or different from each other.

According to another aspect of the present invention, a method for manufacturing an electrode catalyst for a fuel cell includes forming a dispersion of a metal catalyst material supported by a carbon support; and adding a compound of Formula 2, sodium nitrite, and acid to the dispersion, and then, agitating the resultant to obtain a metal catalyst supported by a carbon support combined with a compound of Formula 1 below,

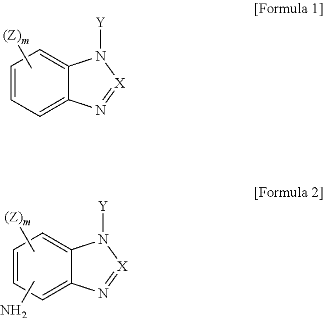

wherein in Formulae 1 and 2, X, Y, Z and m are the same as defined above.

According to another aspect of the present invention, a method for manufacturing an electrode catalyst for a fuel cell includes obtaining a carbon support combined with a compound of Formula 1 below by adding a compound of Formula 2, sodium nitrite, and acid to a carbon support, and then, by agitating; and adding the carbon support to a dispersion of a precursor of a metal catalyst material, and then, agitating the resultant to obtain a metal catalyst supported by a carbon support combined with a compound of Formula 1 below:

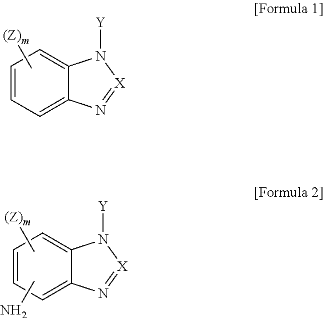

wherein in Formulae 1 and 2, X, Y, Z and m are the same as defined above.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a diagram schematically illustrating an electrode catalyst for a fuel cell according to an embodiment of the present invention;

FIG. 2 is an exploded perspective view of a fuel cell according to another embodiment of the present invention;

FIG. 3 is a cross-sectional view of a membrane-electrode assembly (MEA) of the fuel cell of FIG. 2;

FIG. 4 is an XPS graph of the electrode catalyst manufactured according to Example 1;

FIG. 5 is a graph illustrating the performance of PEMFC manufactured according to Example 1 and Comparative Example 1 of the present invention; and

FIG. 6 is a graph illustrating the 1 kHz resistance of PEMFC manufactured according to Example 1 and Comparative Example 1 of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The electrode catalyst according to an aspect of the present invention includes: a carbon support; a metal catalyst material supported by the carbon support; and a compound of following Formula 1, which is combined with the carbon support.

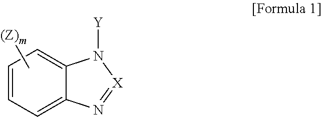

In the above Formula 1, X is N or CR¹, where R′ is a hydrogen atom, C₁-C₆ alkyl or C₁-C₆ haloalkyl,

Y is a hydrogen atom, C₁-C₆ alkyl or C₁-C₆ haloalkyl,

Z is halo, cyano, nitro or hydroxy,

m is an integer of 0 to 3, and

when m is 2 or more, multiple Z are either same as or different from each other.

The electrode catalyst according to an embodiment of the present invention prevents particles of the metal catalyst material from aggregating, and prevents phosphoric acid electrolytes from leaking at a high temperature operation of the fuel cell by virtue of the benzimidazole-based or benzotriazole-based compounds combined in between the particles of the metal catalyst materials supported by the carbon support.

The compound of Formula 1 may be trifluoromethyl benzimidazole or dimethyl benzimidazole.

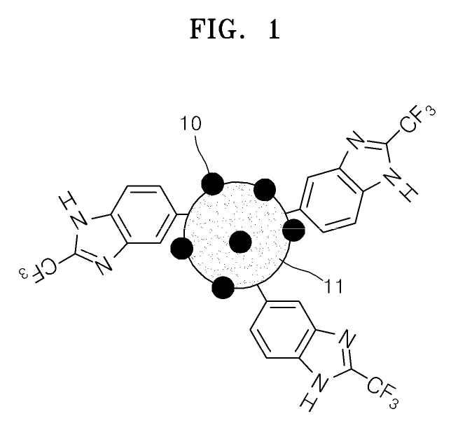

FIG. 1 is a diagram schematically illustrating an electrode catalyst for a fuel cell according to an embodiment of the present invention. Referring to FIG. 1, a metal catalyst material 10 is supported on a carbon support 11, and trifluoromethyl benzimidazole, which is an example of benzimidazole-based compound, is chemically combined with the carbon support 11. In a typical carbon-supported catalyst, only the metal catalyst material 10 is supported on a carbon support 11, but according to this embodiment of the present invention, benzimidazole-based or benzotriazole-based compounds are chemically combined with the carbon support 10 resulting in an improved durability without an unfavorable effect on the activity of a fuel cell.

The metal catalyst material 10 may be one or more metal or alloy selected from the group consisting of platinum, ruthenium, osmium, platinum-ruthenium alloy, platinum-cobalt alloy, platinum-nickel alloy, platinum-iridium alloy, and platinum-osmium alloy.

The carbon support 11 included in the electrode catalyst for fuel cells according to this embodiment of the present invention may be materials such as ketjen black, acetylene black, carbon black, graphite carbon, carbon nanotube, and carbon fiber.

The compound of Formula 1 may be contained at about 1 to about 100 parts by weight based on 100 parts by weight of the carbon support 11. By containing benzimidazole-based or benzotriazole-based compounds within the concentration range above, leakage of phosphoric acid electrolyte and aggregation of metal catalyst materials may be effectively prevented without an unfavorable effect on the activity of the electrode catalyst of the fuel cell.

Metal catalyst material 10 may be contained at about 10 to about 90 weight % based on the total weight of the electrode catalyst of the fuel cell. By containing the metal catalyst material 10 at the above range, activity of the target electrode catalyst may be attained.

According to an aspect of the present invention, the electrode catalyst for the fuel cells may be manufactured through the steps of: dispersing metal catalyst material 10 supported by carbon support 11; adding the compound of Formula 2 below, sodium nitrite and acid to the above dispersion, and then agitating the resultant to obtain metal catalyst material 10 supported by the carbon support 11, which is combined with the compound of Formula 1 below.

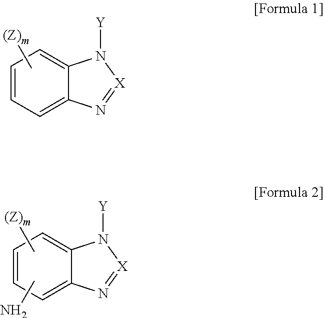

In the above Formulae 1 and 2, X, Y, Z and m are the same as defined above.

The method of dispersing the metal catalyst material 10 supported by the carbon support 11 may include steps of: forming a solution by dissolving the precursor of metal catalyst material 10 in a solvent; and adding the carbon support 11 to the solution and agitating the resultant. After that, the precursor of the metal catalyst material supported by the carbon support is reduced to obtain metal catalyst material 10 supported by the carbon support 11.

The precursor of metal catalyst material 10 may be reduced by adding NaOH to adjust the pH to, e.g., 11, and then, by using an aqueous solution of NaBH₄. The catalyst material obtained after the reduction may be reduced at a hydrogen atmosphere after washing and drying.

The precursor of metal catalyst material 10 may be one or more salts selected from the group consisting of chloride, nitride, sulfide, acetyl acetonate, and cyanide of the metal.

The manufactured metal catalyst material 10 supported by the carbon support 11 is then dispersed into deionized water.

By adding a benzimidazole amine-based compound or benzotriazole amine-based compound, sodium nitride, and acid to the dispersion, and then by agitating the resultant, supported metal catalyst material 10, where the benzimidazole-based compound or benzotriazole-based compound is combined with the carbon support 11, is obtained. Examples of the added acid may include hydrochloric acid, nitric acid, phosphoric acid, and sulfuric acid. More particularly, the acid may be hydrochloric acid.

In another embodiment of the present embodiment, the electrode catalyst for the fuel cells may instead be manufactured through the steps of: adding the compounds of Formula 2 below, sodium nitrite and acid on a carbon support 11, and then agitating the resultant to obtain a carbon support 11 combined with the compound of Formula 1 below; adding the carbon support 11 combined with the compounds of Formula 1 to a dispersion of the precursor of metal catalyst material 10, and then agitating the resultant to obtain metal catalyst material 10 supported by the carbon support 11 that is combined with the compound of Formula 1 below.

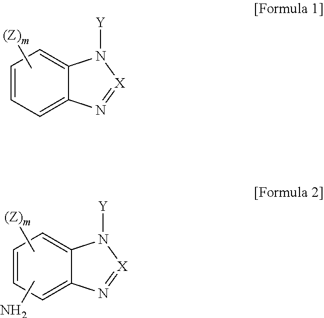

In the above Formulae 1 and 2, X, Y, Z and m are the same as defined above.

In another embodiment of the present invention, obtaining metal catalyst material 10 supported by the carbon support 11 that is combined with the compound of Formula 1 may further include adding a carbon support 11 combined with the benzimidazole-based compound or benzotriazole-based compound of Formula 1 to a dispersion of the precursor of metal catalyst material 10, and then agitating the resultant to obtain the precursor of metal catalyst material 10 supported by the carbon support 11 combined with the benzimidazole-based compound or benzotriazole-based compound, and reducing the precursor of the metal catalyst material 11. The precursor of metal catalyst material 11 may be reduced by adding NaOH to adjust pH to, e.g., 11, and then, by adding an aqueous solution of NaBH₄. The catalyst material obtained after the reduction may be reduced in a hydrogen atmosphere after washing and drying.

The precursor of metal catalyst material 10 may be one or more salt selected from a group consisting of chloride, nitride, sulfide, acetyl acetonate, and cyanide of the metal.

Examples of the added acid may include hydrochloric acid, nitric acid, phosphoric acid, and sulfuric acid. More particularly, the acid may be hydrochloric acid.

In the manufacturing method of the electrode catalyst for the fuel cells according to the above embodiments of the present invention, the reaction mechanism of combination between the carbon support 11 and the benzimidazole-based compound or benzotriazole-based compound may be expressed by the following reaction scheme. This is just for explaining the present invention, and the scope of the present invention is not limited thereto.

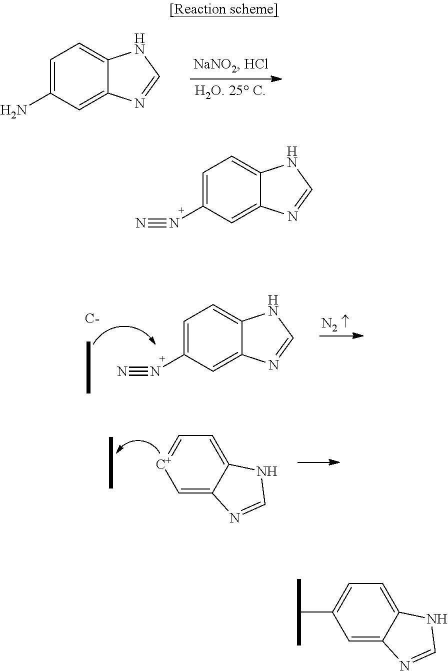

In the above reaction scheme, the benzimidazole-based compound or benzotriazole-based compound reacts with sodium nitride in acid solution to be diazotized. By mixing the obtained diazotized compound with a carbon support 11 and agitating, nitrogen molecules of the diazo compound are separated, and thus the carbon atom of a phenyl ring is combined with a carbon atom of the carbon support 11.

The compound of Formula 2 may be 5-amino-2-(trifluoromethyl)benzimidazole or 2-amino-5,6-dimethylbenzimidazole.

For the carbon support, ketjen black, acetylene black, carbon black, graphite carbon, carbon nanotube, ordered porous carbon, or carbon fiber may be used.

By mixing the metal catalyst material 10 supported by the carbon support 11 combined with a benzimidazole-based compound or benzotriazole-based compound, which is generated in this manner, with binder resin and solvent, slurry is manufactured. By coating a gas diffusion layer with the slurry and drying, an electrode is formed. The drying may be performed at a temperature of about 150° C. For instance, distilled water, N-methylpyrrolidone (NMP), dimethylacetamide (DMAc), dimethylformamide (DMF), trifluoroacetic acid (TFA), or the like may be used for the solvent.

Another aspect of the present invention provides a fuel cell including an electrode including the electrode catalyst, and an electrolyte. The electrode may be an anode or a cathode.

The fuel cell is provided with an anode and a cathode having an electrolyte membrane therebetween. In the anode, a hydrogen oxidation reaction (HOR) occurs so that hydrogen ions and electrons are generated (H²→2H⁺+2e⁻). The hydrogen ions diffuse to the cathode through the electrolyte membrane, and the electrons move along an external circuit. In the cathode, an oxygen reduction reaction (ORR) occurs so that water is generated (2H⁺+2e⁻+1/2O₂→H₂O). Herein, hydrogen ions (H⁺) are supplied from the electrolyte membrane, and electrons are supplied from the external circuit.

The above-described electrode catalyst for a fuel cell may be applied to both of an anode of a fuel cell where HOR occurs and a cathode where ORR occurs. The fuel cell may be realized with, e.g., phosphoric acid fuel cell (PAFC), polymer electrolyte membrane fuel cell (PEMFC), or direct methanol fuel cell (DMFC).

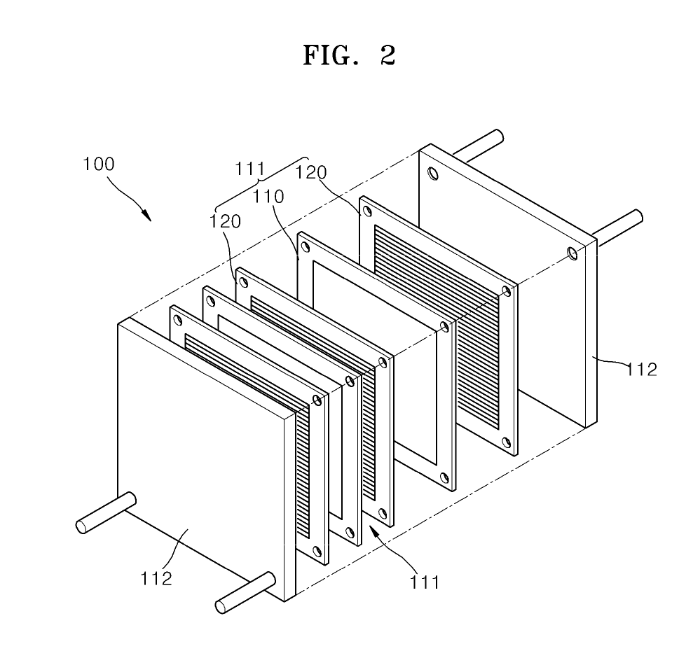

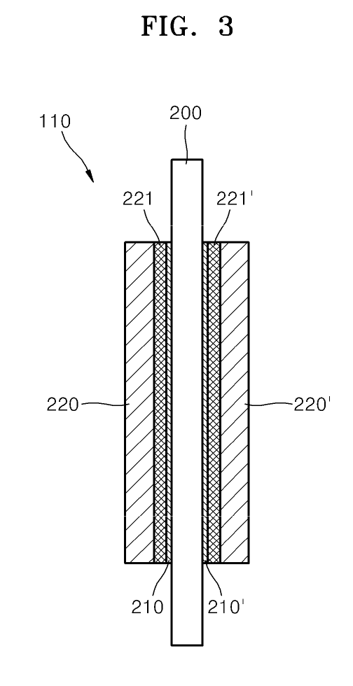

FIG. 2 is an exploded perspective view of a fuel cell according to another embodiment of the present invention, and FIG. 3 is a cross-sectional view of the membrane-electrode assembly (MEA) comprising the fuel cell of FIG. 2.

The fuel cell 100 illustrated in FIG. 2 schematically consists of two unit cells 111 supported by a pair of holders 112. The unit cell 111 consists of a membrane-electrode assembly 110, and bipolar plates 120 disposed on opposite sides of the membrane-electrode assembly 110 in the thickness direction of the membrane-electrode assembly 110. The bipolar plates 120 are composed of conductive metal or carbon. Being joined to the membrane-electrode assembly 110, the bipolar plates 120 function as current collectors and also supply oxygen and fuel to catalyst layers of the membrane-electrode assembly 110.

Meanwhile, although two unit cells 111 are illustrated in FIG. 2, the number of unit cells may be increased to several tens to several hundred according to the required characteristics of the fuel cell.

As illustrated in FIG. 3, the membrane-electrode assembly 110 may consist of an electrolyte membrane 200; catalyst layers 210 and 210′ arranged at both sides of the electrolyte membrane 200 in the thickness direction of the electrolyte membrane 200, to which an electrode catalyst according to an embodiment of the present invention is applied; first gas diffusion layers 221 and 221′ respectively layered on the catalyst layers 210 and 210′; and second gas diffusion layers 220 and 220′ respectively layered on the first gas diffusion layers 221 and 221′.

The catalyst layers 210 and 210′ function as a fuel electrode and an oxygen electrode, respectively, and include catalysts and binders. Materials for increasing the surface area of the catalyst may be further included.

The first gas diffusion layers 221 and 221′ and the second gas diffusion layers 220 and 220′ may be respectively formed of carbon sheet, carbon paper, carbon fabric, and carbon felt, etc. and diffuse oxygen and fuel supplied through the bipolar plates 120 over the catalyst layers 210 and 210′.

The fuel cell 100 including the membrane-electrode assembly 110 is operated in a temperature range of about 40° C. to about 300° C. Hydrogen is supplied as fuel to one catalyst layer through the bipolar plate 120 and oxygen is supplied as an oxidizing agent to the other catalyst layer through the bipolar plate 120. In one catalyst layer, hydrogen is oxidized thereby generating hydrogen ions (H⁺), and the hydrogen ions (H⁺) are transmitted through the electrolyte membrane 200 to reach the other catalyst layer. In the other catalyst layer, the hydrogen ions (H⁺) and oxygen electrochemically react with each other thereby generating water (H₂O) and electric energy simultaneously. Herein, the hydrogen supplied as fuel may be generated by reforming a hydrocarbon or an alcohol, and the oxygen supplied as an oxidizing agent may be supplied by being included in the ambient air.

Hereinafter, the present invention will be described in detail giving an example and a comparative example; however the following embodiment is described just for clarity of explanation of the present invention, and the present invention is not limited thereto.

### Example 1

### Manufacturing PtCo/C-trifluoromethylbenzimidazole

1.0 g of PtCo/C, which is commercially available, was dispersed in 500 ml of deionized water. 0.06 g of 5-amino-2-(trifluoromethyl)benzimidazole, 0.02 g of NaNO₂, and 0.03 ml of an aqueous solution of HCl were added to the dispersion, and then the dispersion was agitated for 12 hours at 300 rpm. Then, the dispersion was filtered, washed by distilled water, and dried for about 12 hours to obtain a metal catalyst supported by a carbon support combined with trifluoromethylbenzimidazole.

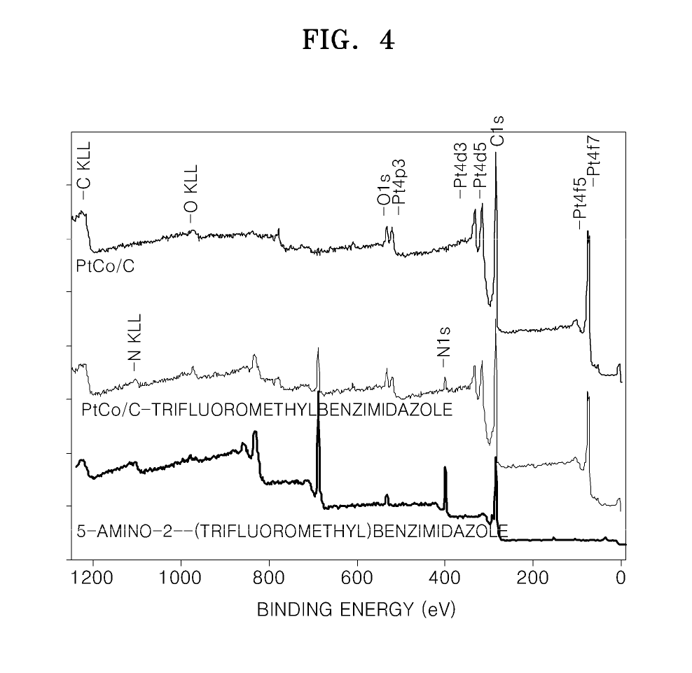

FIG. 4 is an XPS graph which shows that the benzimidazole compound is chemically combined with a carbon support in the above-manufactured electrode catalyst. As illustrated in FIG. 4, changes of C1s peak and N1s peak confirm that a carbon atom of the carbon support is combined with a carbon atom of the benzene ring.

Manufacturing Fuel Cell

For manufacturing the cathode of a PEMFC, 0.03 g of polyvinylidene fluoride (PVDF) per 1 g of the above-manufactured catalyst was mixed with an appropriate amount of the solvent N-methyl-2-pyrrolidone to manufacture a slurry for forming a cathode. The cathode slurry was coated on carbon paper coated with a microporous layer using a bar coater. Then, in a drying process the temperature was increased stepwise from room temperature to 150° C. Thus, a cathode was manufactured.

Using a PtRu/C catalyst, an anode was manufactured in the same manner as the above-described method for manufacturing a cathode.

Poly(2,5-benzimidazole) doped with about 85% phosphoric acid was used as an electrolyte membrane between the anode and cathode to manufacture the PEMFC.

Then, using non-humidified air for a cathode and non-humidified hydrogen for an anode, performance of the PEMFC was evaluated at a temperature of 150° C.

### Comparative Example 1

An electrode and a fuel cell including the electrode were manufactured in the same manner as the above-described method of Example 1 except that the manufacturing process of combining trifluoromethylbenzimidazole with a carbon support was omitted.

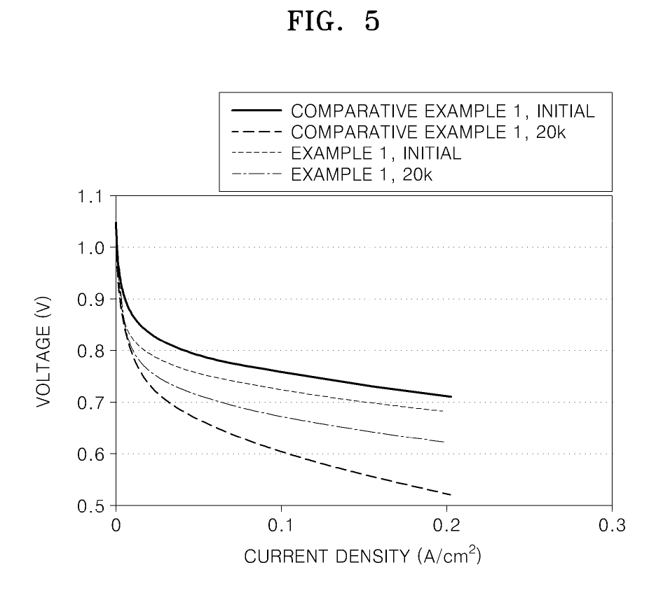

FIG. 5 is a graph illustrating the performance of a fuel cell (PEMFC) manufactured according to Example 1 and Comparative Example 1. Performance was evaluated at a temperature of about 150° C. using non-humidified air for the cathode and non-humidified hydrogen for the anode. Current density was increased stepwise from 0 A/cm² to 0.2 A/cm², and the operating voltage as a function of the current density was recorded. In addition, for evaluating durability of a fuel cell, the cell voltage was maintained at 1.3 V for 30 seconds and 0.9 V for 30 seconds. Voltages as a function current density after an initial cycle and 20,000 cycles were measured, and the results are illustrated in FIG. 5.

As illustrated in FIG. 5, a fuel cell including an electrode catalyst according to an embodiment of the present invention has excellent durability when the fuel cell is operated at a high temperature.

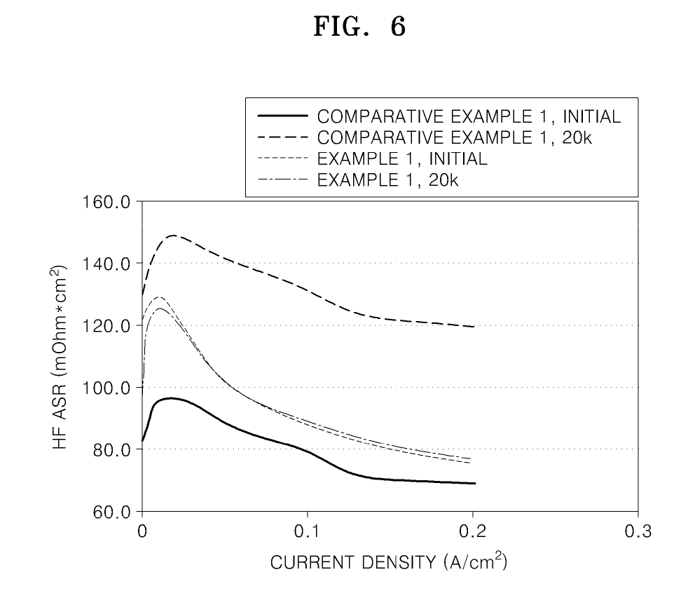

FIG. 6 is a graph illustrating the 1 kHz resistance of a fuel cell manufactured according to Example 1 and Comparative Example 1. As illustrated in FIG. 6, the 1 kHz resistance of a fuel cell according to this embodiment of the present invention was not greatly increased even after the cycle operation. Therefore, it may be determined that benzimidazole combined with a carbon support prevents leakage of phosphoric acid electrolytes.

According to an aspect of the present invention, a fuel cell with excellent durability can be manufactured by manufacture of carbon supports combined with benzimidazole-based or benzotriazole-based compounds.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode catalyst for a fuel cell, comprising:
a carbon support;
a metal catalyst material supported by the carbon support; and
a compound of Formula 1 below combined with the carbon support, 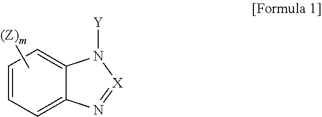
wherein Formula 1:
X is N or CR¹, where R¹ is a hydrogen atom, C₁-C₆ alkyl or C₁-C₆ haloalkyl,
Y is a hydrogen atom, C₁-C₆ alkyl or C₁-C₆ haloalkyl,
Z is halo, cyano, nitro or hydroxy,
m is an integer of 0 to 3, and
when m is 2 or more, multiple Z's are either the same as or different from each other.

2. The electrode catalyst for a fuel cell of claim 1, wherein the metal catalyst material is one or more metals or alloys selected from the group consisting of platinum, ruthenium, osmium, platinum-ruthenium alloy, platinum-cobalt alloy, platinum-nickel alloy, platinum-iridium alloy, and platinum-osmium alloy.

3. The electrode catalyst for a fuel cell of claim 1, wherein the concentration of the compound of the Formula 1 is about 1 to about 100 parts by weight based on 100 parts by weight of the carbon support.

4. The electrode catalyst for a fuel cell of claim 1, wherein the compound of Formula 1 is trifluoromethylbenzimidazole or dimethylbenzimidazole.

5. The electrode catalyst for a fuel cell of claim 1, wherein the carbon support is one or more carbonaceous material selected from the group consisting of ketjen black, acetylene black, carbon black, graphite carbon, carbon nanotube, ordered porous carbon, and carbon fiber.

6. The electrode catalyst for a fuel cell of claim 1, wherein the amount of the metal catalyst material is about 10 weight % to about 90 weight % based on the total weight of the catalyst.

7. A method for manufacturing an electrode catalyst for a fuel cell, comprising:
dispersing a metal catalyst material supported by a carbon support in a solvent;
adding a compound of Formula 2, sodium nitrite, and acid to the dispersion; and
agitating the resultant to obtain a metal catalyst supported by a carbon support combined with a compound of Formula 1 below, 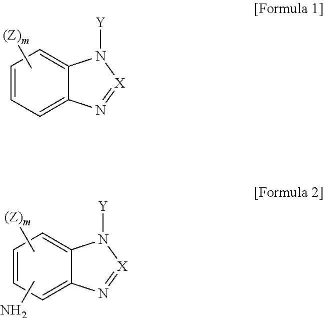
wherein in Formulae 1 and 2:
X is N or CR¹, where R¹ is a hydrogen atom, C₁-C₆ alkyl or C₁-C₆ haloalkyl,
Y is a hydrogen atom, C₁-C₆ alkyl or C₁-C₆ haloalkyl,
Z is halo, cyano, nitro or hydroxy,
m is an integer of 0 to 3, and
when m is 2 or more, multiple Z's are either the same as or different from each other.

8. A method for manufacturing an electrode catalyst for a fuel cell, comprising:
adding a compound of Formula 2, sodium nitrite, and acid to a carbon support;
agitating the resultant;
adding the carbon support to a dispersion of a precursor of a metal catalyst material, and
agitating the resultant to obtain a metal catalyst supported by a carbon support combined with a compound of Formula 1 below, 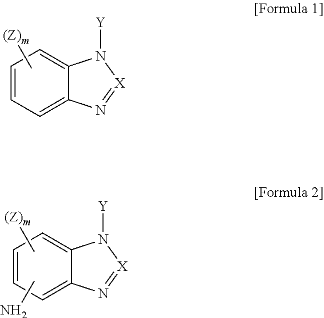
wherein in Formulae 1 and 2:
X is N or CR¹, where R¹ is a hydrogen atom, C₁-C₆ alkyl or C₁-C₆ haloalkyl,
Y is a hydrogen atom, C₁-C₆ alkyl or C₁-C₆ haloalkyl,
Z is halo, cyano, nitro or hydroxy,
m is an integer of 0 to 3, and
when m is 2 or more, multiple Z's are either the same as or different from each other.

9. The method of claim 7, wherein the compound of Formula 1 is 5-amino-2-(trifluoromethyl)benzimidazole or 2-amino-5,6-dimethylbenzimidazole.

10. The method of claim 7, wherein the acid is hydrochloric acid, sulfuric acid, nitric acid, or phosphoric acid.

11. The method of claim 7, wherein dispersing the metal catalyst material supported by the carbon support comprises:
forming a solution by dissolving a precursor of a metal catalyst material in a solvent;
adding a carbon support to the solution; and
agitating the mixture.

12. The method of claim 11, wherein the precursor of the metal catalyst is one or more salts selected from the group consisting of chloride, nitride, sulfide, acetyl acetonate, and cyanide of the metal.

13. A fuel cell, comprising:
an electrode comprising an electrode catalyst for a fuel cell according to one claim 1; and
an electrolyte membrane.

14. The method of claim 8, wherein the compound of Formula 1 is 5-amino-2-(trifluoromethyl)benzimidazole or 2-amino-5,6-dimethylbenzimidazole.

15. The method of claim 8, wherein the acid is hydrochloric acid, sulfuric acid, nitric acid, or phosphoric acid.

16. The method of claim 8, wherein the precursor of the metal catalyst is one or more salts selected from the group consisting of chloride, nitride, sulfide, acetyl acetonate, and cyanide of the metal.

17. The method of claim 8, wherein adding the carbon support to a dispersion of a precursor of a metal catalyst material further comprises reducing the precursor of the metal catalyst material supported by the carbon support.
